(19) United States
(12) Patent Application Publication
(10) Pub. No.: US 2013/0240045 A1
(43) Pub. Date: Sep. 19, 2013

(54) Method for Determining a Fluid Flow Rate With a Fluid Control Valve

(71) Applicant: Xiufeng Pang, (US)

(72) Inventor: Jingjuan FENG, Walnut Creek, CA (US)

(73) Assignee: Xiufeng Pang, Walnut Creek, CA (US)

(21) Appl. No.: 13/674,187

(22) Filed: Nov. 12, 2012

Related U.S. Application Data
(60) Provisional application No. 61/611,088, filed on Mar. 15, 2012.

(51) Int. Cl. G01F 1/56

(52) U.S. Cl. CPC G01F 1/56
USPC 137/10

(57) ABSTRACT

A method for determining a fluid flow rate with a fluid control valve utilizes inherent characteristics of a particular valve in conjunction with easily measured parameters in order to determine a flow rate through the valve. A valve flow characteristic equation, a flow coefficient, and a rangeability for the valve are known and hardcoded into a chipset that controls the valve. A differential pressure transducer measures the pressure drop across the valve. A valve actuator controls the valve opening fraction. The differential pressure transducer and the valve actuator provide feedback signals to the chipset. The known and measured parameters are used to calculate an instantaneous valve characteristic and a fully-open flow rate for the valve. The instantaneous flow rate through the valve is then calculated from the instantaneous valve characteristic and the fully-open flow rate.

The current application claims a priority to the U.S. Provisional Patent application Ser. No. 61/611,088 filed on Mar. 15, 2012.

### FIELD OF THE INVENTION

The present invention relates generally to fluid flows. More particularly, the present invention relates to a method for determining the rate of flow of a fluid in a pipe utilizing a measured differential pressure and valve stem position in concert with provided manufacturer's specifications.

### BACKGROUND OF THE INVENTION

In many industries, such as oil, gas, mining, heating, ventilation, and air conditioning (HVAC) and power, control valves are often used in the industrial process to regulate the flow rate or the pressure of a piping system. Control valves are valves used to control conditions such as flow, pressure, temperature, and liquid level by fully or partially opening or closing in response to signals received from controllers that compare a “setpoint” to a “process variable” whose value is provided by sensors that monitor changes in such conditions. Often, it is desirable or required to quantify bulk fluid movement, or flow, through a pipe, and a flow meter must be installed in the piping system. Many different methods for flow measurement and flow meters exist, including mechanical flow meters, pressure-based flow meters, optical flow meters, vortex flow meters, and coriolis flow meters. However, current flow measurement solutions have several drawbacks. The flow meters themselves are expensive and require long, straight pipe upstream and downstream of the installed flow meter. Current flow meters also introduce an additional pressure drop into the system, resulting in increased pump energy consumption and reducing energy efficiency.

Is it therefore an object of the present invention to provide a method for calculating the flow rate in a pipe through a control valve utilizing inherent valve characteristics and easily obtainable inputs that can be integrated with a control valve to create a novel control valve or implemented as a retrofit kit to a control valve installed in a hydraulic loop. The method can be implemented for any type of control valve provided that certain characteristics are provided by the manufacturer and the valve opening fraction and the differential pressure across the valve can be measured.

### BRIEF DESCRIPTION OF THE DRAWINGS

FIG. 1 is a stepwise flow diagram describing the overall process of the present invention.

FIG. 2 is a block diagram describing the electrical and operative connections between components required to implement the present invention.

FIG. 3 is a diagram giving examples of flow characteristics for different types of valves.

FIG. 4 is a schematic diagram of a control valve including a direction of flow describing the configuration of components required to implement the present invention.

### DETAIL DESCRIPTIONS OF THE INVENTION

All illustrations of the drawings are for the purpose of describing selected versions of the present invention and are not intended to limit the scope of the present invention.

The present invention is a method for determining a fluid flow rate in a piping system using a fluid control valve and a differential pressure transducer. The method can be integrated with a control valve to create a novel control valve, or the method can be implemented with an existing control valve already installed in a hydraulic loop by a retrofit kit. Comparing to current flow measurement devices, a control valve with the method of the present invention integrated is low-cost and maintenance free without the requirement for a long, straight pipe demanded by most current flow measurement devices. The present invention may be utilized with a wide variety of valves, as long as certain inherent characteristics of the valve are known. The present invention requires three valve characteristics provided by the manufacturer and two easily obtainable inputs, the differential pressure across the valve and the valve stem position, or the valve opening fraction.

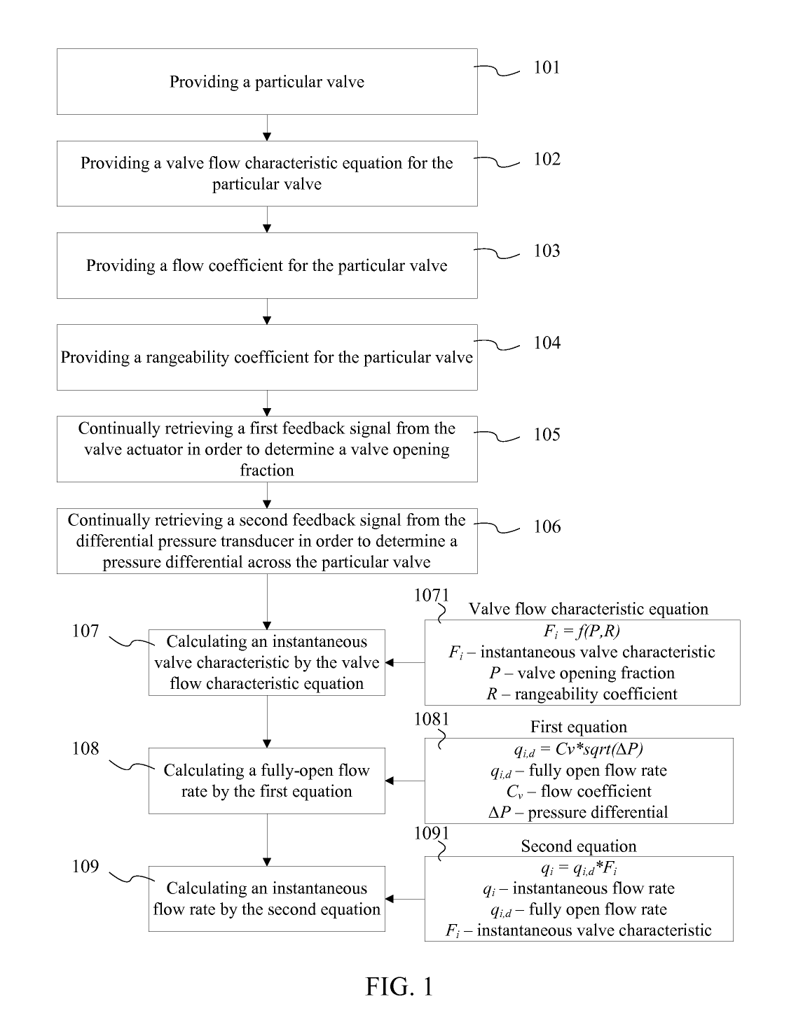

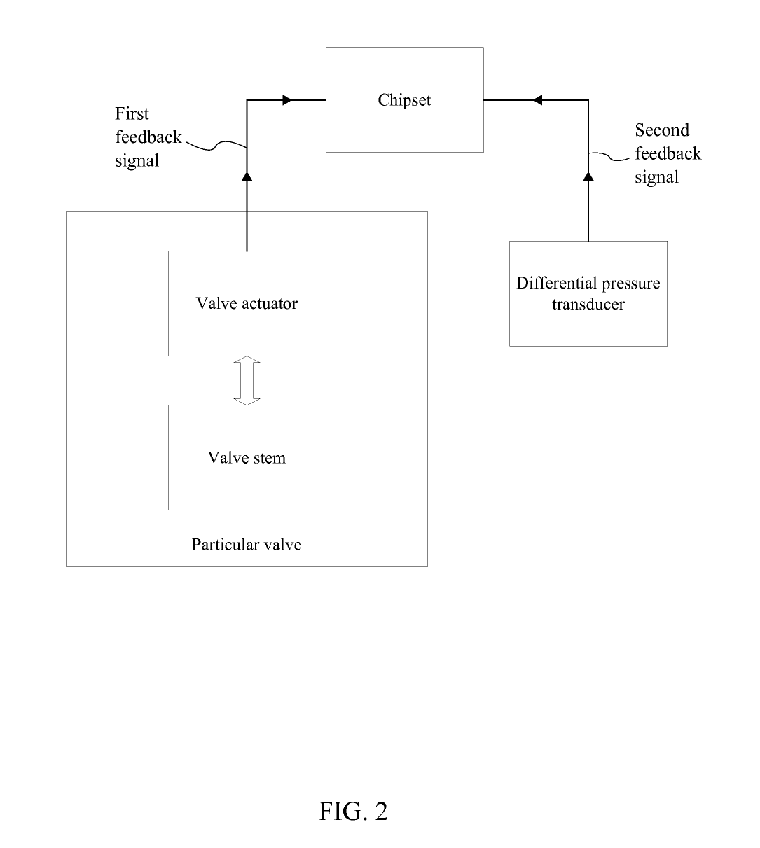

Referring to FIGS. 1 and 2, a particular valve is provided to be utilized with the method of the present invention 101. The particular valve is utilized by the method of the present invention by a chipset, a valve actuator, a valve stem, and a differential pressure (DP) transducer. The chipset is a component or combination of components of the electronic variety such as, but not limited to, circuit boards, wires, storage devices, and processors necessary to facilitate the translation of electrical input signals into desired effects and electrical output signals in the operation of the system. The valve actuator is the physical mechanism of the particular valve that converts energy into some kind of motion in order to change the valve opening fraction by moving the valve stem. For example, in a globe valve, the valve stem rotates in a screwing motion to convert angular force into a linear motion, forcing a plug into or out of a hole to throttle the flow through the valve. The valve actuator is the mechanical means of rotating the valve stem.

The differential pressure transducer is a well-known device that measures a differential pressure. The differential pressure transducer may be any kind of pressure measurement device that suits the application of measuring a pressure drop across a valve and producing a digital signal that can be interpreted by the chipset, such as, but not limited to, pressure taps, a manometer, a Bourdon pressure gauge, or a pitot tube. The differential pressure transducer measures a differential pressure across the particular valve and transmits a feedback signal to the chipset.

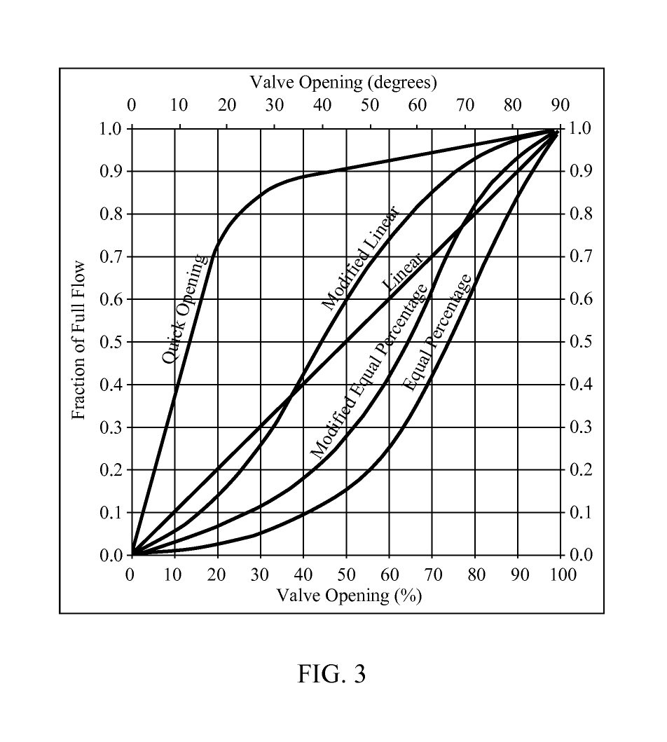

Three properties of the particular valve must be provided by the manufacturer or otherwise known: a flow characteristic equation 102, a flow coefficient 103, and a rangeability coefficient 104. Referring to FIG. 3, the flow characteristic equation represents a curve specific to the particular valve used that defines the flow rate through the particular valve expressed as a fraction of the design flow rate for the particular valve as a function of the valve opening fraction under constant differential pressure across the valve. The flow coefficient is a value specific to the particular valve that expresses the flow capacity of water under certain conditions, such as having a temperature of 60 degrees Fahrenheit and a pressure drop of 1 pound per square inch difference (psid). The rangeability coefficient is a value specific to the particular valve that represents the ratio of maximum flow to minimum flow through the particular valve for which the flow characteristic equation is valid. The flow characteristic equation, the flow coefficient, and the rangeability coefficient are provided by the manufacturer of the particular valve or otherwise known and hardcoded onto the chipset.

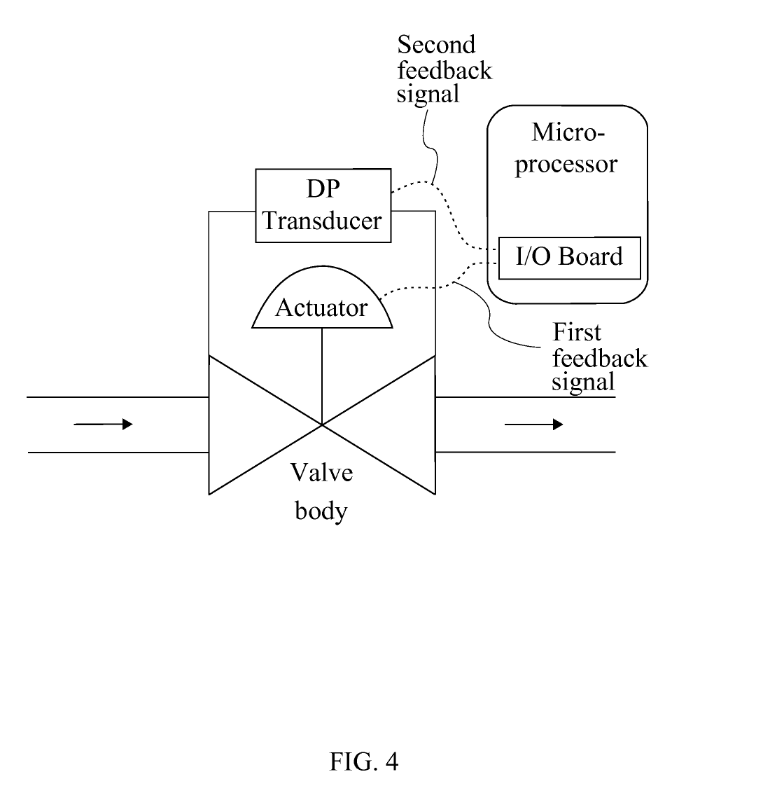

Referring to FIGS. 2 and 4, the chipset executes digital commands to implement the method of the present invention. The valve actuator is electronically connected to the chipset and operatively coupled to the valve stem, so that the chipset controls the position of the valve stem through the valve actuator in order to control the valve opening fraction. The chipset sends signals to the valve actuator that cause the valve actuator to convert a source of energy into a specified amount of motion to precisely control the position of the valve stem. The chipset continually retrieves a first feedback signal from the valve actuator, allowing the chipset to continually determine the valve opening fraction of the particular valve in a manner common to feedback control systems 105.

The differential pressure transducer is electronically connected to the chipset, so that a second feedback signal continually retrieved by the chipset from the differential pressure transducer allows the chipset to determine the differential pressure across the particular valve 106.

Knowing the valve flow characteristic equation, the flow coefficient, the rangeability coefficient, the valve opening fraction, and the differential pressure across the particular valve, the instantaneous flow rate through the particular valve may be calculated.

An instantaneous valve characteristic is calculated by inputting the valve opening fraction and the rangeability coefficient into the valve flow characteristic equation and solving the valve flow characteristic equation for the instantaneous valve characteristic 107. The instantaneous valve characteristic is a point on the valve flow characteristic curve that represents the ratio of an instantaneous flow rate to a fully-open flow rate at the point in time the instantaneous valve characteristic is calculated. For the particular valve, the valve flow characteristic equation is given as:

Fᵢ=f(P,R)1071

Referring to FIG. 2, the instantaneous valve characteristic, Fᵢ is defined based on the type of valve by an equation involving the valve opening fraction, P, and the rangeability, R. Different kinds of valves have different valve flow characteristic equations which must be provided by the manufacturer.

A fully-open flow rate is calculated by inputting the flow coefficient and the differential pressure into a first equation and by solving the first equation for the fully-open flow rate 108. The first equation is given as:

q_{i,d}=Cᵥ*sqrt(ΔP)1081

The fully-open flow rate, q_{i,d}, is determined by multiplying the flow coefficient, Cᵥ, by the square root of the differential pressure ΔP.

With the instantaneous valve characteristic and the fully-open flow rate known, the instantaneous flow rate is calculated by inputting the fully-open flow rate and the instantaneous valve characteristic into a second equation and by solving the second equation for the instantaneous flow rate 109. The second equation is given as:

qᵢ=q_{i,d}*Fᵢ 1091

The instantaneous flow rate, qᵢ, is determined by multiplying the fully open flow rate q_{i,d} by the instantaneous valve characteristic Fᵢ.

To demonstrate the spirit of the present invention through an example, an example particular valve has a valve flow characteristic equation defined as:

F=R^{(P-1)}

The inherent valve characteristic F is found my raising the rangeability coefficient R to the power of the valve opening fraction P minus 1. The example particular valve also has a flow coefficient of 70 and a rangeability coefficient of 50.

The first feedback signal is retrieved from the valve actuator, determining the valve opening fraction to be 30%, or 0.3. The second feedback signal is retrieved from the differential pressure transducer, determining the differential pressure across the example particular valve to be 9 psid.

The instantaneous valve flow characteristic of the example particular valve is calculated by the valve flow characteristic equation as:

Fᵢ=50^{(0.3-1)}=0.064673

The fully-open flow rate through the example particular valve at the measured differential pressure is calculated by the first equation as:

q_{i,d}=70*sqrt(9)=210 gallons per minute (GPM)

The instantaneous flow rate through the example particular valve is calculated by the second equation as:

qᵢ=210*0.064673=13.58 GPM

The previously described method may be utilized in several applications. Integrating the method with any type of valve may produce a new valve system that measures the flow rate through a pipe in addition to modulating the flow rate through the pipe. For the method to be utilized to such ends, the system requires basic components, such as a valve body, the actuator appropriate for the type of valve body, a differential pressure transducer and a control device that implements the method, as previously described. The valve body may comprise a ball valve, a butterfly valve, a globe valve or any other valve that suits the application. The control device utilizes the previously described method to calculate the instantaneous flow rate, which may be displayed locally on a digital display screen and/or electronically sent to a separate control location, preferably as an analog signal in either the 4-20 milliamp range or the 0-10 volt range through a communication interface utilizing common communication protocols such as, but not limited to, BACnet or Modbus.

The previously described method can be used to implement a regular control valve with additional flow measurement capability, enhancing the robustness of the control system. One practical application is in the heating, ventilation, and air circulation (HVAC) industry where a control valve is used to modulate the hot or chilled water flowing through a heating or cooling coil in order to maintain discharge air at a temperature setpoint. The building automation system compares the measured discharge air temperature of the heating or cooling coil with the temperature setpoint, then calculates the required valve opening and sends out a control command. The new valve executes the command while simultaneously measuring the instantaneous flow rate through the valve and sending the flow rate measurement to the building automation control system. The building automation system may then use the flow measurement for various purposes, such as, but not limited to, Fault Detection and Diagnosis or energy consumption monitoring.

An additional application of the previously described method is to create a pressure-independent control valve that takes a remote signal as the flow rate setpoint. A proportional-integral-derivative (PID) controller computes the control command and modulates the actuator to utilizing well known control methods to maintain a flow rate through the control valve at the set point independent of pressure fluctuations in the hydraulic loop.

A third application of the previously described method is to create an automatic balancing valve. In the commissioning phase of a newly installed hydraulic system, a balancing process takes place to ensure each branch of the hydraulic system receives the flow rate it was designed for by adjusting a balancing valve in each branch. The traditional balancing process requires several iterations and is very time consuming. The new automatic balancing valve is similar in principle to the pressure-independent control valve, but with the flow rate setpoint input locally, preferably through a digital interface. The new automatic balancing valve also eliminates the need for an input/output (I/O) board and communication interface necessary to communicate with a remote control system.

Although the invention has been explained in relation to its preferred embodiment, it is to be understood that many other possible modifications and variations can be made without departing from the spirit and scope of the invention as hereinafter claimed.

What is claimed is:

1. A method for determining a fluid flow rate with a fluid control valve comprises the steps of,
providing a particular valve, wherein the particular valve comprises a chipset, a valve actuator, a valve stem, and a differential pressure transducer;
providing a valve flow characteristic equation for the particular valve, wherein the flow characteristic equation defines a normalized flow rate as a function of a valve opening fraction;
providing a flow coefficient for the particular valve, wherein the flow coefficient expresses the flow capacity of the particular valve under specified conditions;
providing a rangeability coefficient for the particular valve, wherein the rangeability coefficient represents the ratio of maximum to minimum flow rate through the particular valve the valve flow characteristic equation is applicable for;
continually retrieving a first feedback signal from the valve actuator in order to determine the valve opening fraction;
continually retrieving a second feedback signal from the differential pressure transducer in order to determine a differential pressure across the particular valve;
calculating an instantaneous valve characteristic by inputting the valve opening fraction and the rangeability coefficient into the valve flow characteristic equation and by solving the valve flow characteristic equation for the instantaneous valve characteristic, wherein the instantaneous valve characteristic represents a ratio of an instantaneous flow rate to a fully-open flow rate for the particular valve;
calculating the fully-open flow rate by inputting the flow coefficient and the differential pressure into a first equation and by solving the first equation for the fully-open flow rate; and
calculating the instantaneous flow rate through the particular valve by inputting the fully open flow rate and the instantaneous valve characteristic into a second equation and by solving the second equation for the instantaneous flow rate.

2. The method for determining a fluid flow rate with a fluid control valve as claimed in claim 1 comprises the steps of,
calculating the instantaneous valve characteristic by means of the valve flow characteristic equation:
Fᵢ=f(P,R)
wherein the instantaneous valve characteristic Fᵢ is defined based on the type of valve by an equation involving the valve opening fraction P and the rangeability R.

3. The method for determining a fluid flow rate with a fluid control valve as claimed in claim 1 comprises the steps of,
calculating the fully open flow rate by means of the first equation:
q_{i,d}=Cᵥ*sqrt(ΔP)
wherein the fully open flow rate q_{i,d} is determined by multiplying the flow coefficient Cᵥ by the square root of the differential pressure ΔP.

4. The method for determining a fluid flow rate with a fluid control valve as claimed in claim 1 comprises the steps of,
calculating the instantaneous flow rate through the particular valve by means of the second equation:
qᵢ=q_{i,d}*Fᵢ
wherein the instantaneous flow rate qᵢ is determined by multiplying the fully open flow rate q_{i,d} by the instantaneous valve characteristic Fᵢ.

5. The method for determining a fluid flow rate with a fluid control valve as claimed in claim 1, wherein the chipset is electronically connected to the differential pressure transducer and the valve actuator.

6. The method for determining a fluid flow rate with a fluid control valve as claimed in claim 1, wherein the valve actuator is operatively coupled to the valve stem.

7. The method for determining a fluid flow rate with a fluid control valve as claimed in claim 1, wherein the valve flow characteristic equation, the flow coefficient, and the rangeability coefficient are hardcoded onto the chipset.

8. A method for determining a fluid flow rate with a fluid control valve comprises the steps of,
providing a particular valve, wherein the particular valve comprises a chipset, a valve actuator, a valve stem, and a differential pressure transducer;
providing a valve flow characteristic equation for the particular valve, wherein the flow characteristic equation defines a normalized flow rate as a function of a valve opening fraction;
providing a flow coefficient for the particular valve, wherein the flow coefficient expresses the flow capacity of the particular valve under specified conditions;
providing a rangeability coefficient for the particular valve, wherein the rangeability coefficient represents the ratio of maximum to minimum flow rate through the particular valve the valve flow characteristic equation is applicable for;
continually retrieving a first feedback signal from the valve actuator in order to determine the valve opening fraction;
continually retrieving a second feedback signal from the differential pressure transducer in order to determine a differential pressure across the particular valve;
calculating an instantaneous valve characteristic by inputting the valve opening fraction P and the rangeability coefficient R into the valve flow characteristic equation:
Fᵢ=f(P,R)
wherein the valve flow characteristic equation is solved for the instantaneous valve characteristic Fᵢ;
wherein the instantaneous valve characteristic represents a ratio of an instantaneous flow rate to a fully-open flow rate for the particular valve;
wherein the instantaneous valve characteristic Fᵢ is defined based on the type of valve by an equation involving the valve opening fraction P and the rangeability R.
calculating the fully open flow rate by inputting the flow coefficient and the differential pressure into a first equation:
q_{i,d}=Cᵥ*sqrt(ΔP)
wherein the first equation is solved for the fully open flow rate q_{i,d} by multiplying the flow coefficient Cᵥ by the square root of the differential pressure ΔP; and
calculating the instantaneous flow rate through the particular valve by inputting the fully open flow rate and the instantaneous valve characteristic into a second equation:
qᵢ=q_{i,d}*Fᵢ
wherein the second equation is solved for the instantaneous flow rate qᵢ by multiplying the fully open flow rate q_{i,d} by the instantaneous valve characteristic Fᵢ.

9. The method for determining a fluid flow rate with a fluid control valve as claimed in claim 8, wherein the chipset is electronically connected to the differential pressure transducer and the valve actuator;

10. The method for determining a fluid flow rate with a fluid control valve as claimed in claim 8, wherein the valve actuator is operatively coupled to the valve stem;

11. The method for determining a fluid flow rate with a fluid control valve as claimed in claim 8, wherein the valve flow characteristic equation, the flow coefficient, and the rangeability coefficient are hardcoded onto the chipset;

12. A method for determining a fluid flow rate with a fluid control valve comprises the steps of,
providing a particular valve, wherein the particular valve comprises a chipset, a valve actuator, a valve stem, and a differential pressure transducer;
wherein the valve actuator is operatively coupled to the valve stem;
wherein the chipset is electronically connected to the differential pressure transducer and the valve actuator;
providing a valve flow characteristic equation for the particular valve, wherein the flow characteristic equation defines a normalized flow rate as a function of a valve opening fraction;
wherein the valve flow characteristic equation is hardcoded into the chipset;
providing a flow coefficient for the particular valve, wherein the flow coefficient expresses the flow capacity of the particular valve under specified conditions;
wherein the flow coefficient is hardcoded into the chipset;
providing a rangeability coefficient for the particular valve, wherein the rangeability coefficient represents the ratio of maximum to minimum flow rate through the particular valve the valve flow characteristic equation is applicable for;
wherein the rangeability coefficient is hardcoded into the chipset;
continually retrieving a first feedback signal from the valve actuator in order to determine the valve opening fraction;
continually retrieving a second feedback signal from the differential pressure transducer in order to determine a differential pressure across the particular valve;
calculating an instantaneous valve characteristic by inputting the valve opening fraction and the rangeability coefficient into the valve flow characteristic equation and by solving the valve flow characteristic equation for the instantaneous valve characteristic, wherein the instantaneous valve characteristic represents a ratio of an instantaneous flow rate to a fully-open flow rate for the particular valve;
calculating the fully-open flow rate by inputting the flow coefficient and the differential pressure into a first equation and by solving the first equation for the fully-open flow rate; and
calculating the instantaneous flow rate through the particular valve by inputting the fully open flow rate and the instantaneous valve characteristic into a second equation and by solving the second equation for the instantaneous flow rate.

13. The method for determining a fluid flow rate with a fluid control valve as claimed in claim 12 comprises the steps of,
calculating the instantaneous valve characteristic by means of the valve flow characteristic equation:
Fᵢ=f(P,R)
wherein the instantaneous valve characteristic Fᵢ is defined based on the type of valve by an equation involving the valve opening fraction P and the rangeability R.

14. The method for determining a fluid flow rate with a fluid control valve as claimed in claim 12 comprises the steps of,
calculating the fully open flow rate by means of the first equation:
q_{i,d}=Cᵥ*sqrt(ΔP)
wherein the fully open flow rate q_{i,d} is determined by multiplying the flow coefficient Cᵥ by the square root of the differential pressure ΔP.

15. The method for determining a fluid flow rate with a fluid control valve as claimed in claim 12 comprises the steps of,
calculating the instantaneous flow rate through the particular valve by means of the second equation:
qᵢ=q_{i,d}*Fᵢ
wherein the instantaneous flow rate qᵢ is determined by multiplying the fully open flow rate q_{i,d} by the instantaneous valve characteristic Fᵢ.
